(19) United States
(12) Patent Application Publication
(10) Pub. No.: US 2014/0076244 A1
(43) Pub. Date: Mar. 20, 2014

(54) MODULAR ANIMAL LEAD AND RESTRAINT

(71) Applicant: Michael Byrne, Cambridge, MA (US)

(72) Inventor: Philip Byrne, Cambridge, MA (US)

(21) Appl. No.: 14/032,182

(22) Filed: Sep. 19, 2013

Related U.S. Application Data
(60) Provisional application No. 61/703,246, filed on Sep. 19, 2012.

(51) Int. Cl. A01K 27/00

(52) U.S. Cl. CPC A01K 27/003
USPC 119/798; 119/799

(57) ABSTRACT

A modular semi-rigid animal lead and restraint, comprising a rigid or semi-rigid staff portion to which may be attached a flexible or semi-rigid leash portion, optionally further comprising a variety of modular attachment points such as rings, clips, threaded studs or sockets, or additional leashes or leash attachment means.

### CROSS-REFERENCE TO RELATED APPLICATIONS

This application claims priority to U.S. Provisional Patent Application, Ser. No. 61/703,246, titled “The Puppy Wand”, and filed on Sep. 19, 2012, the entire specification of which is incorporated herein by reference.

### BACKGROUND OF THE INVENTION

1. Field of the Invention

The invention relates to the field of animal restraints, and more particularly to the field of leads and leashes.

2. Discussion of the State of the Art

In the art of animal restraints, there is a class of devices of a “leash” or “lead” type, as may be commonly utilized for such purposes as walking an animal (such as a pet dog) or for restraining or directing an animal (such as in zookeeping or wildlife management duties). Such devices are generally utilized to control direction or movement of an animal, or to maintain a safe distance from a handler. In common usage, leashes are frequently utilized with pet animals such as cats and dogs, to prevent an animal from wandering off or to aid in training (such as teaching an animal how to maintain pace with a handler, or perform certain behaviors on command).

In some uses, such as walking a pet animal in public areas or wilderness, there may be a risk of interaction from another, potentially hostile animal such as a feral dog or a wildcat. Often, handlers in such situations may need to carry some form of self-defense or distraction device in addition to their animal lead, necessitating extra bulk and weight as well as the possibility of “fumbling” or failing to manipulate one or both devices properly under duress, with potentially dire consequences.

In other situations, such as pet owners simply walking their animal in a park or other public area, self-defense may not be a concern but other utility may require additional devices to be carried or utilized, such as plastic bags for cleaning up animal waste, or food or “treat” items for rewarding animal behavior. Again, such instances require the handler to carry additional bulk and manipulate extra items while maintaining control of an animal lead.

What is needed is a device that allows both restraint or control of an animal, as well as providing additional functions such as self-defense or other utility to combine functions into a single device for simplicity of operation and ease of carry.

### SUMMARY OF THE INVENTION

Accordingly, the inventor has conceived and reduced to practice, in a preferred embodiment of the invention, a modular semi-rigid animal lead and restraint device. The device of the invention may utilize a modular design to provide a variety of additional features or functions as described below, while at the same time performing the basic functions of an animal lead or restraint without unnecessary manipulation by a handler.

According to a preferred embodiment of the invention, a semi-rigid animal lead comprising a rigid “staff” portion and a flexible “leash” portion, is disclosed. According to the embodiment, a rigid staff may be utilized such as to provide leverage and various functions such as maintaining a minimum distance from a restrained animal (such as may be useful for zookeeping or veterinary practices, where dangerous or hostile animals may be interacted with) or for self-defense against a hostile animal (such as, for example, a pet owner walking their dog that may be attacked by a wild animal or another owner's hostile dog). Such a staff may be of varied construction such as (or example) varying in length or thickness while allowing for a comfortable or secure grip by a handler, and may be constructed utilizing a variety of materials such as wood, metal, polymer, or other suitable materials interchangeably or in tandem. Affixed to a staff may be an attachment means for a flexible leash, such as a metal clip or ring to which a leash may be attached while allowing for free movement, such as attachments commonly used in leash and collar devices common in the art. In this manner, an animal may be permitted a degree of movement by utilizing varying leash lengths or designs, while still allowing for utility provided by a rigid staff, such as described above and in greater detail below (Referring to FIG. 1 and FIG. 2).

According to the embodiment, a handler may be allowed to control an animal primarily with one hand on a staff portion of the invention and one hand free, as opposed to a typical non-rigid leash which requires two hands to maintain control of excess length or “slack” in the leash.

According to the embodiment, this means of control may be accomplished with one hand on a staff holding the staff at its balance point and tilting the staff an appropriate amount to vary leash slack or tension, and prevent an animal from either trampling the leash or straying too far from the handler. With their free hand, a handler can offer treat rewards while training, use a cell phone, deliver manual commands to an animal (i.e., commands utilizing hand motions in conjunction with or in place of verbal commands), or any other suitable action that may require the use of a hand.

Further according to the embodiment, by manipulating a rigid staff portion to control an attached flexible lead, a handler may have a greater degree of control over a lead and any animal being restrained. If a leash is trampled by an animal, a handler may not need to stoop down to remove the leash from between the animals feet, the handler can simply point the staff portion to the ground with a restraint end (i.e., the distal end to which a flexible lead is affixed) on the ground and pull the wand away from the animal. Since the pulling force is coming from in front of the animal at ground level, the leash easily slides under the animal's feet. This may be a great benefit for older or less mobile handlers. Additionally, unlike retractable leashes there is practically no risk of rope burn or dangerous snap back at the handler during manipulation, as a handler.

Additionally, animals on leashes may be frequently let off the leash to exercise. Retrieval of an unleashed animal, particularly a small one can be dangerous to the animal if it requires the handler grabbing on to a part of the animal such as a leg or tail and also dangerous to the handler if they slip or are elderly or less mobile and try to run in a bent over position to catch an animal. According to the embodiment, the invention may be used like a held lasso if the handler holds the staff at the handle end in one hand and the leash clip of the leash section in the other to form a V shape, the apex of which, when pointed away from the handler, can be lowered about the head of the animal to very effectively restrain it from fleeing.

Regarding self-defense of a handler or protection of a leashed animal, the invention may be utilized in a variety of offensive or defensive ways when needed. Separation of the leash from the staff allows the staff to be used as a defensive, fending, or offensive device against an attack by another animal or person, while allowing the handler to maintain separate control of the handler's animal, particularly when the connecting clip has a metal buckle, or the heavy end of a staff portion is used to strike with force. More typically, the staff can be used to poke away an aggressive animal, even while still attached to the leash, or it can be the object that an aggressive animal takes into its mouth, as opposed to the handler's arm or leg.

To protect a leashed animal from more common hazards such as trash, debris, or toxic material that an animal might attempt to eat, the invention allows a handler to pin objects to the ground or sidewalk (or strike them away from the animal's reach) that an animal may attempt to ingest from the ground or sidewalk much faster than if a handler attempts to remove the ingestible item manually or by foot, without the risk of placing the handler's hand or foot between the animal's mouth and the object it wants to ingest. The handler can reach the item faster with the end of the staff or he may also use the end of the staff to block the animal's mouth from ingesting the item.

A further benefit of the invention is that should an animal leash become spiraled or tangled with another animal's leash, as frequently happens (for example with two pet owners walking their dogs), typically one animal handler will need to drop their leash to aid in untangling of the leashes. According to the embodiment, use of a detachment point (such as a detachable connection between a staff and lead portion of the invention) allows a much easier way to untangle without losing control of either animal by (continuing the prior example of two pet owners with dogs on leashes) having the handler reach to the leash portion of the invention at the dogs collar, and sliding the handler's hand up the leash to the disconnect clip and disconnecting and separating the leash section from the staff section. Since the handler still holds the lower portion of the Puppy Wand, the staff section allows the other handler's leash to slide off the staff easily, enabling the leashes to be untangled with ease while maintaining control of both animals.

According to another embodiment of the invention, a semi-rigid animal lead comprising a rigid staff portion and a flexible leash portion, wherein the staff portion may have a plurality of modular attachment points, is disclosed. According to the embodiment, a rigid staff portion may have one or more modular attachment points such as for the attachment of various accessory items to increase utility, such as a bag dispenser for cleaning up animal waste, a food or treat item storage or dispenser for feeding an animal or rewarding behavior, visual or auditory signaling devices for use as training aids (such as laser pointers or audible buzzers, clickers, or whistles as are common in the art), or any other device that may be desirable to integrate or attach to a staff such that it may be readily utilized without needing to be operated or manipulated separately by a handler. In this manner, multiple functions may be provided without requiring a handler to carry or operate multiple devices, minimizing the risk of losing control of a device or of an animal and decreasing unneeded weight and bulk.

According to the embodiment, attachment points may vary in nature, such as (for example) a staff end (such as an end nearest to a handler, when a distal end may have a flexible leash attached as described previously) having a threaded knob, stud, or socket to which accessories may be attached, or having a plurality of fixed or movable attachment points along the length of a staff, such as metal or plastic rings, clips, loops, or other attachment means to which devices may be affixed. It should be appreciated that the specific nature of attachment means may vary widely, and any suitable attachment means or device may be utilized according to the invention. It should also be appreciated that additional flexible leads may be added by affixing to attachment points, such as may be desirable for managing multiple animals simultaneously (for example, a professional dog walker).

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is an illustration of an exemplary device according to a preferred embodiment of the invention.

FIG. 2 is a further illustration of an exemplary device, illustrating modular attachment means, according to an embodiment of the invention.

### DETAILED DESCRIPTION

The inventor has conceived, and reduced to practice, a modular semi-rigid animal lead and restraint device.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Definitions

A “handler”, as used herein, may refer to any user that may utilize the disclosed invention, such as a person walking a dog, an animal trainer, a zookeeper, or any other such individual that may benefit from the utility described herein.

An “animal”, as used herein, may refer to any creature that may be suitably restrained or controlled by the device of the invention, such as a dog, cat, or any other animal. Throughout this document, examples may described the use of the invention in conjunction with a dog, as the inventor has conceived that such is a common situation where the use of the device of the invention may be appropriate, however it should be noted that such examples are meant only as a readily recognizable demonstration of utility and should not be construed as limiting of the invention or its utility, and that any animal may be substituted according to the invention.

### DETAILED DESCRIPTION OF EXEMPLARY EMBODIMENTS

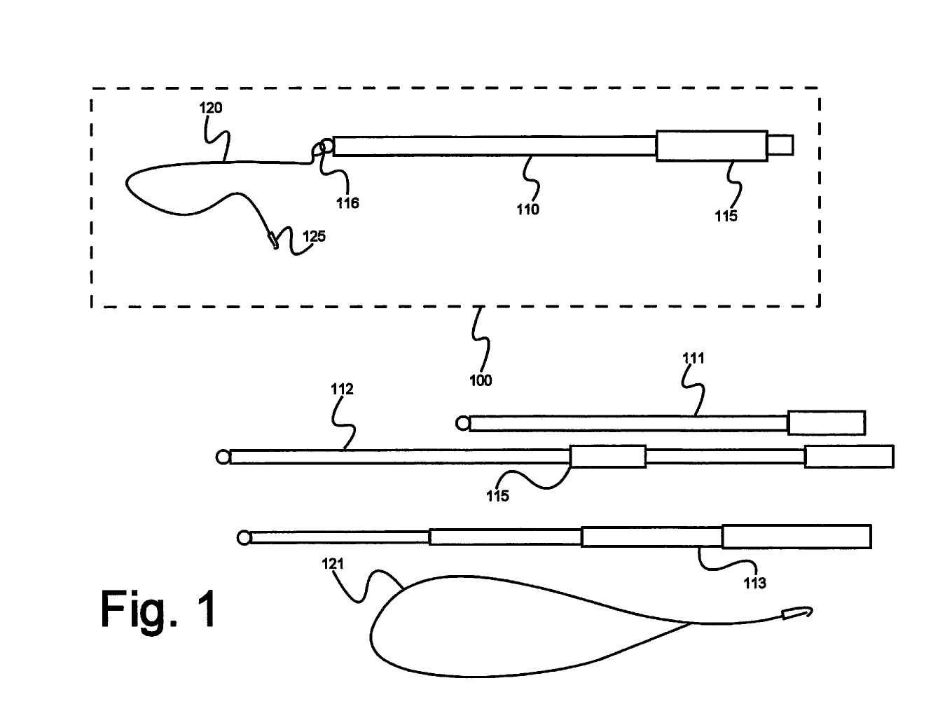

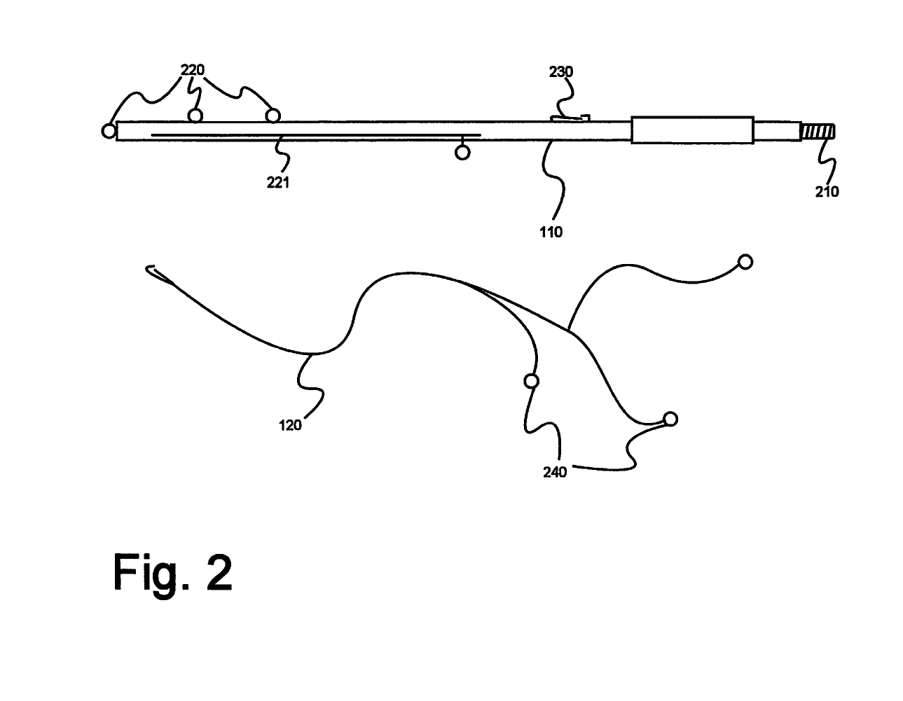

FIG. 1 is an illustration of an exemplary animal lead and restraint device 100, according to a preferred embodiment of the invention. As illustrated, device 100 may comprise a rigid or semi-rigid staff portion 110, a flexible or semi-rigid leash portion 120 (that may further comprise an attachment means 125 such as to attach to an animal's collar or harness), and an attachment means 116 that may be utilized to movably connect the two. It should be appreciated that such connection may be permanent or temporary in nature, i.e. a flexible leash 120 may be detached from a staff 110 as appropriate, such as to release a restrained animal (for example, after maneuvering the animal into an enclosure such as a crate or pen). Additionally, a staff 110 may utilize a textured or padded grip 115, such as to facilitate positive retention or increased handler comfort or ergonomics during use. It should be further appreciated that such a grip may be applied interchangeably (such as removable texture “stickers” or adhesive decals), or removably affixed (such as via a threaded accessory system as described below, referring to FIG. 2) to a staff 110, such that a variety of alternate grips may be utilized with a single staff according to handler preference.

As illustrated, a variety of configurations of both a staff 110 and a lead 120 portion may be utilized interchangeably according to the invention, such as (but not limited to) a shorter 111 or longer 112 staff (As may be utilized to accommodate handlers of varying stature, or to accommodate different uses such as a longer staff to hold a dangerous animal at a safe distance), a staff with a second handgrip portion 115 such as for greater control of large or dangerous animals, a segmented or collapsible staff 113 such as for travel use, a traditional leash 120 such as is common for use with domesticated dogs and that may be used to clip onto a collar or harness worn by an animal (not shown), or a loop-style restraint 121 such as may be used in wildlife services or zookeeping, such as for the capture or restraint of potentially dangerous or hostile animals, and that may be maneuvered around a portion of an animal's body (such as a limb or neck). In this manner, a modular design can be utilized to accommodate a variety of handlers and animals, as well as a variety of potential uses according to various scenarios according to the invention.

FIG. 2 is a further illustration of an exemplary device 200 according to a further embodiment of the invention. As illustrated, a variety of modular attachment points may be utilized according to the invention, such as a threaded knob 210 (which may alternately take the form of a threaded stud or a socket interchangeably according to the invention, facilitating a variety of similar functions) affixed or integrally molded into a staff portion 110 (to which various accessories may be affixed such as by screwing onto a threaded knob or stud, or screwing into a socket), a plurality of fixed or removable attachment rings 220 or clips 230 to which accessory items may be clipped, snapped, or otherwise attached. As illustrated, such attachment points may be movably affixed or integrated into a staff 110, such as by means of a sliding track or groove 221 to facilitate free movement of an attachment point (such as may be desirable for attaching additional leashes, to allow more movement of animals without interfering with one another). Additionally, a plurality of removable or movably affixed attachment clips 240 may be utilized on a leash portion 120 to which additional accessories or other leashes may be attached (such as for the handling of multiple animals with a single staff 110).

It should be appreciated that in this manner, a wide variety of accessory items and attachments may be accommodated by a single staff 110 or leash 120 according to the invention, and it should be further appreciated that various modular means illustrated are exemplary and various alternate or additional means may be utilized according to the invention, and further that various arrangements of modular means may be utilized according to the invention and the configuration and arrangement shown is exemplary.

The skilled person will be aware of a range of possible modifications of the various embodiments described above. Accordingly, the present invention is defined by the claims and their equivalents.

What is claimed is:

1. A modular semi-rigid animal lead and restraint, comprising:
a rigid staff; and
a flexible leash;
wherein the staff and leash are attached via movable means.

2. The device of claim 1, further comprising a grip portion;
wherein the grip is affixed about or attached to the staff.

3. The device of claim 1, further comprising a plurality of modular attachment points;
wherein the attachment point is affixed or integral to the staff.

4. The device of claim 3, further comprising a plurality of modular leash attachments;
wherein the leash attachment is affixed or integral to the leash.

5. The device of claim 3, wherein the attachment point is movable about the staff.

6. The device of claim 3, wherein the attachment point may be a solid ring.

7. The device of claim 3, wherein the attachment point may be a clip.

8. The device of claim 3, wherein the attachment point may be threaded.

9. The device of claim 1, wherein the staff is collapsible.

10. The device of claim 1, wherein the leash is a fixed loop.
